(19) United States
(12) Patent Application Publication
(10) Pub. No.: US 2026/0012534 A1
(43) Pub. Date: Jan. 8, 2026

(54) Capturing Wireless Device Usage Data

(71) Applicant: Global Wireless Solutions, Inc., Dulles, VA (US)

(72) Inventors: Paul Patrick Carter, Paeonian Springs, VA (US); Qingzhong Hu, Boxborough, MA (US); Rikard Olof Roland Lundqvist, Ashburn, VA (US)

(21) Appl. No.: 18/766,056

(22) Filed: Jul. 8, 2024

(51) Int. Cl. H04M 1/72463; G06V 20/40

(52) U.S. Cl. CPC H04M 1/72463; G06V 20/40

(57) ABSTRACT

Aspects described herein relate to various methods, systems and apparatuses that may be used to capture wireless device usage data. An operating system may place limits, or restrictions, on how the wireless device usage data can be viewed and/or processed by third-party applications. However, by implementing the various methods, systems, and apparatuses described herein, the wireless usage data can be captured in a way that circumvents and/or avoids the limits, or restrictions, placed on the wireless device usage data by the operating system. Further aspects relate to performing the capture of the wireless device usage data based on user authorization. Yet further aspects relate to using the wireless device usage data to improve various processes for determining network performance.

### BACKGROUND

Wireless devices may, via a variety of software applications installed on the device, provide a variety of services to users. For example, a wireless device may provide, among other services, a browser service that allows a user to view websites, a voice call service that allows a user to conduct voice calls, and a text messaging service that allows a user to send/receive text messages. Users may also install and use a variety of applications to suit their own needs and preferences. Collecting and analyzing data indicating how a user uses their wireless device can be useful in identifying a user's needs and preferences. Once a user's needs and preferences are identified, various services can be enriched based on the user's needs and preferences. Due to the enriching effect caused by identifying a user's needs and preferences, an operating system of a wireless device may be constantly collecting and accumulating data that indicates how a user uses their wireless device. However, the operating system may place limits, or restrictions, on how that data can be viewed and/or processed by third-party applications. As an example, the particular wireless device operating system may allow third-party applications to view what applications were used by a user and how long a user stays within an application, but may not allow third-party applications to view what a user did within an application (e.g., for an application that provides a movie service, the operating system may not allow third-party applications to see what movie(s) a user watched). As another example, a different operating system may allow for third-party applications to view data indicating what applications were used by a user of a wireless device when the wireless device is running in a development or debug mode, but may restrict third-party applications from sending data indicating what applications were used via a network or to another application executing on the wireless device. A user's experience of their wireless device and/or their chosen services may both be diminished by an operating system enforcing such limits and restrictions.

### BRIEF SUMMARY

This summary is provided to introduce a selection of concepts in a simplified form that are further described below in the Detailed Description. This Summary is not intended to identify key features or essential features of the various embodiments, nor is it intended to be used to limit the scope of any claim.

There is an ever-present need to improve a user's experience of their wireless device and their chosen services. In view of this ever-present need, aspects described herein relate to various methods, systems and apparatuses that can be used to capture wireless device usage data that is subject limits or restrictions enforced by an operating system of the wireless device. The wireless device usage data may, among other things, indicate how a user is using or has used their wireless device, such as by indicating which applications were used by user, indicating a period of time during which the user was within an application, and the like. Various aspects described herein may relate to circumventing, or otherwise avoiding, the limits and restrictions that are placed on the wireless device usage data by the operating system of the wireless device. Additionally, the various aspects described herein may relate to performing the capture of the wireless device usage data and/or the circumvention based on a user's authorization. As one brief example, the capture of the wireless device usage data may include receiving the user's authorization to record video of display screens that include depictions of wireless device usage data, recording the video based on the user's authorization, extracting the wireless device usage data from the display screens, and forwarding the wireless device usage data for further analysis and/or use.

Additional aspects may relate to ways in which the wireless device usage data may be further analyzed and/or used. For example, some variations described below may include analyzing and/or using the wireless device usage data as part of a system that determines network performance. In this way, wireless device usage data, which was captured in a way that circumvents a limit or restriction placed by the wireless device's operating system, may be used to improve methods that determine network performance.

### BRIEF DESCRIPTION OF THE DRAWINGS

Some example embodiments are illustrated by way of example and not limited in the accompanying figures in which like reference numerals indicate similar elements and in which:

FIG. 1 shows a block diagram of an example computing environment in which wireless device usage data may be captured from one or more wireless devices.

FIG. 2 shows a block diagram of an example wireless device with an operating system that places one or more limits or restrictions on wireless device usage data in accordance with various aspects described herein.

FIGS. 3A-3D show example flows for capturing wireless device usage data in accordance with various aspects described herein.

FIG. 4 shows an example method that records video and captures wireless device usage data in accordance with various aspects described herein.

FIG. 5 shows an example method for displaying one or more display screens that depict the wireless device usage data, and capturing of the wireless device usage data, in accordance with various aspects described herein

FIG. 6 shows an apparatus that may be used to implement one or more aspects described herein.

FIG. 7 shows an example display of usage data in accordance with various aspects described herein.

### DETAILED DESCRIPTION

In the following description of various illustrative embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

Various aspects described herein relate to the capture of wireless device usage data. Wireless device usage data may indicate how a user is using and/or has used their wireless device. There are many ways in which the wireless device usage data may indicate how a user is using and/or has used their wireless device. For example, wireless device usage data may indicate what applications run on the wireless device were used by a user, how long a user stays within an application, how many notifications from the applications are received, how often the wireless device was picked up by the user, how often an application lights up the screen of the wireless device, etc. Wireless device usage data may indicate usage over particular periods of time (e.g., what applications were used over one or more weeks, what applications were used over one or more months, and the like). Wireless device usage data may indicate various indications of peak usage (e.g., a time of day when the wireless device is continually used by a user, a period of time that indicates the longest time a user stayed within an application, and the like). Wireless device usage data may indicate various indications of low usage (e.g., a time of day when the wireless device was continually not used by a user, a period of time that indicates the longest time the wireless device was idle, and the like). In general, the wireless device usage data may depend on the operating system of the wireless device and the various pieces of information that the operating system collects and/or accumulates as the wireless device is used, or not used, by a user. For simplicity, wireless device usage data will be interchangeably referred herein as usage data.

An operating system may place, or enforce, limits or restrictions on how wireless device usage data can be viewed and/or processed by third-party applications. As an example, an operating system (e.g., ANDROID®) may allow third-party applications to view what applications were used by a user and how long a user stays within an application. The operating system may not allow (e.g., restrict) third-party applications to view what a user did within an application (e.g., for an application that provides a movie service, the operating system may not allow third-party applications to see what movie(s) a user watched). Other operating systems may have different permissions and restrictions, such as allowing third-party applications to view (e.g., record, acquire) wireless device usage data when the wireless device is running in a development or debug mode, but restricting or limiting the third-party applications to acquire the wireless device usage data or send it outside of the wireless device via a network or to another application executing on the wireless device. Aspects described herein may improve methods apparatus, and systems for capturing wireless device usage data that is subject to one or more limits or restrictions enforced by an operating system of the wireless device.

For clarity and for purposes of this disclosure, a third-party application is any application developed by a developer that is not part of the operating system of the wireless device (e.g., that may be installed or un-installed by the user or that is not essential for operating the wireless device). Third-party applications may additionally or alternatively include applications for which its complete functionality may be limited (e.g., by setting a permission level) by the operating system. For users to be able to install a third-party application on a wireless device, the developer of the third-party application may be required to submit the third-party application to the developer of the operating system (e.g., to GOOGLE LLC or APPLE, INC.). The developer of the operating system may review the third-party application and, upon completion of the review, provide the third-party application to users via an application store. Users may then be able to download and install the third-party application to their wireless devices via the application store.

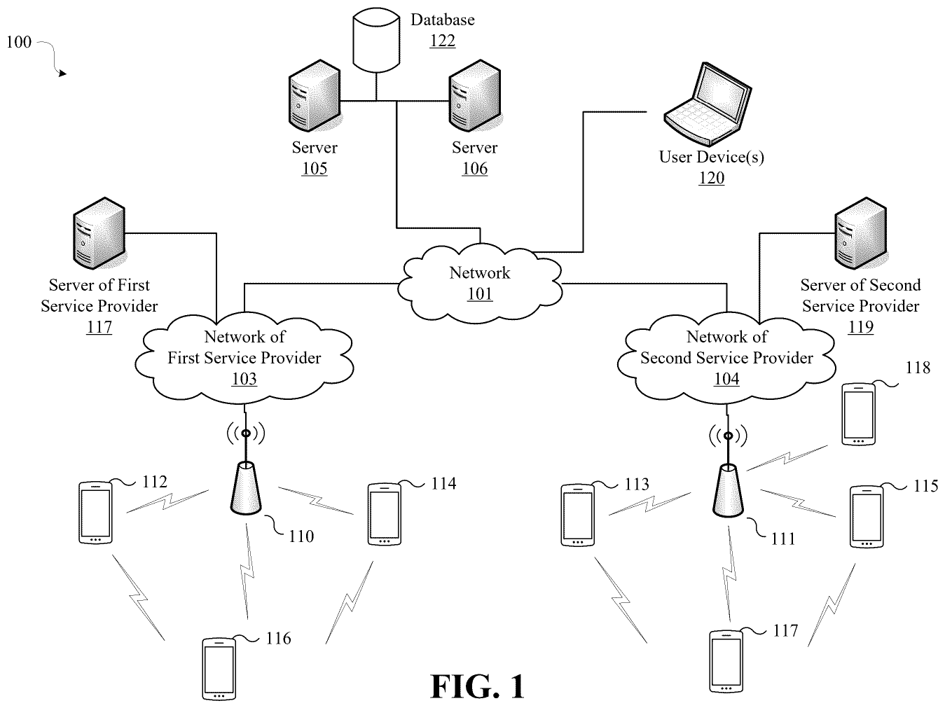

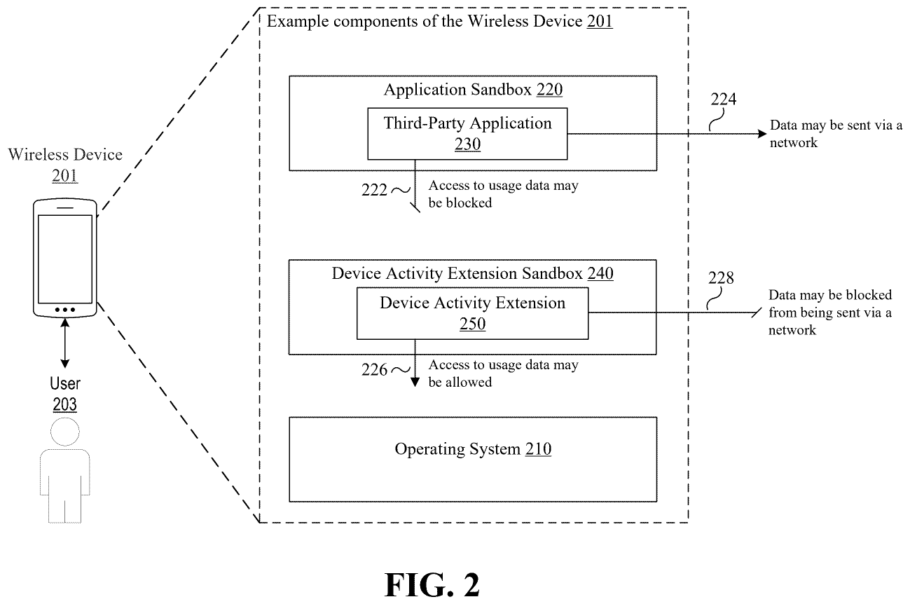

As a general introduction to the discussion below and the accompanying figures, FIG. 1 shows a block diagram of an example computing environment 100 in which usage data may be captured from one or more wireless devices (e.g., wireless devices 112-118 and/or any wireless devices among the one or more user devices 120). Further, the example computing environment 100 is depicted as including one or more devices that may further analyze and/or use the usage data. In particular, server 105 (e.g., a measurement server) and/or server 106 (e.g., a ranking server) may perform various processes for determining network performance (e.g., determine a ranking of two or more wireless networks' performance) and may use the usage data captured from any of the wireless devices as part of the various processes for determining network performance. Servers 105 and 106 may perform other processes, such as analyzing the usage data to evaluate and improve the performance of certain applications. For example, usage data may indicate which features of a certain application do not get used often, and may be eliminated. As another example, usage data may be used to detect, evaluate, and/or optimize power consumption, memory usage, and stability of an application run on different wireless devices and/or in different configurations and/or with different operating system versions. In this way, the example computing environment 100 provides an example as to how capturing usage data in accordance with the aspects described herein may improve methods that determine network performance and/or improve a third-party application that provides a network performance service. Further details regarding the manner in which usage data is captured and how those improvements may be achieved are discussed below in connection with the remaining discussion of FIG. 1 as well as the discussion of FIGS. 2, 3A-3D, 4 and 5.

FIG. 1 depicts two example wireless networks 103 and 104, and a number of wireless devices that may be used to, among other things, capture usage data. Each of the two wireless networks 103 and 104 is depicted in FIG. 1 as being associated with its own service provider. As depicted in FIG. 1, network 103 is associated with a first service provider and network 104 is associated with a second service provider. The first service provider and the second service provider may be different corporate entities that provide, via the associated wireless network, one or more wireless telecommunication services to one or more users (e.g., voice call services, data upload/download services, and the like). Wireless networks 103 and 104 may provide services to the same geographic area (e.g., two wireless networks that provide services to a city) or may provide services to different geographic areas (e.g., wireless network 103 may provide services to a portion of New York, and wireless network 104 may provide services to a portion of Virginia). The example showing two different wireless networks and two different service providers are only an example. There could be more than two wireless networks and/or more than two service providers (e.g., three wireless networks may provide services to a geographic area; each of the three or more wireless networks may be associated with its own service provider). There could be fewer wireless networks and/or fewer service providers (e.g., two wireless networks of a single service provider may be providing services to different geographic areas; a single wireless network of a service provider may be providing services to a geographic area).

Both wireless networks 103 and 104 may be or include a radio access network (RAN), a cellular network, a wireless local access network (WLAN), or some other type of mobile telecommunication network. Each wireless network 103 and 104 may comprise RAN equipment and a core network operated by the associated service provider. The RAN equipment and the core network may be configured to communicate with user devices and provide services to the user devices. The RAN equipment may include, for example, one or more base transceiver stations (BTSs) or one or more access points. As depicted in FIG. 1, wireless network 103 may include a BTS or access point 110, and wireless network 104 may include a BTS or access point 111. Based on the BTS or access point, the RAN equipment may be configured to communicate wirelessly with nearby devices. As depicted in FIG. 1, wireless network 103, based on the BTS or access point 110, may communicate with wireless devices 112, 114, and 116. Wireless network 104, based on the BTS or access point 111, may communicate with wireless devices 113, 115, 117, and 118. The wireless communication with the RAN equipment may be performed according to a wireless standard (e.g., third generation (3G), fourth generation (4G), or fifth generation (5G) mobile telecommunications technology). Each of wireless devices 112-118 may be, for example, a mobile phone, a tablet device, or some other wireless device capable of communicating with a wireless network via a wireless standard.

The wireless devices 112-118 may be configured to send one or more data communications for transport via the wireless network 103 or 104. Once a data communication is received by the RAN equipment of the wireless network 103 or 104, the data communication may be processed by the core network of the wireless network 103 or 104, and routed to its intended destination. In some instances, the intended destination may be outside the core network and, accordingly, may be routed via one or more other networks including, for example, the Internet, a local area network, a wide area network, and the like. FIG. 1 depicts the one or more other networks as network 101. Accordingly, network 101 may include the Internet, one or more local area networks, one or more wide area networks, one or more one or more wired networks, one or more wireless networks, or one or more other types of networks. As examples of intended destinations of a data communication, FIG. 1 depicts measurement server 105, ranking server 106, and one or more user devices 120.

The wireless devices 112-118 may be configured to send one or more data communications to each other. Further, the wireless devices 112-118 may be configured to send the one or more data communications based on a wireless technology different from the wireless networks 103 and 104. For example, the wireless devices 112-118 may be configured to send the one or more data communications based on short-range wireless technology, such as BLUETOOTH, ZIGBEE, or some other short wavelength wireless technology.

Further, each of wireless devices 112-118 may be executing a particular operating system, such as ANDROID, iOS, iPadOS, macOS, watchOS, Kindle, Harmony OS, Amazfit OS, ANDROID ONE, BharOS, Tizen, BlackBerry Secure, CalyxOS, HUAWEI EMUI, Amazon Fire OS, MIUI, Pixel, Wear OS, or other operating systems. The particular operating system may place, or enforce, one or more limits or restrictions how usage data can be viewed and/or processed by third-party applications. According to various aspects described herein, each of wireless devices 112-118 may implement software that allows for the capture of the usage data in a way that circumvents and/or avoids the one or more limits or restrictions. Further, each of wireless devices 112-118 may implement software that receives user authorization to circumvent and/or avoid the one or more limits or restrictions.

Devices, such as the server 105, the server 106, and the one or more user devices 120, may be configured to send one or more data communications to the wireless devices 112-118. The one or more data communications may be transported via the wireless networks 103 or 104. In addition to communicating with the wireless devices 112-118, the measurement server 105 and the ranking server 106 may be configured to communicate with database 122, the one or more user devices 120, the server 121 of the first service provider, and the server 119 of the second service provider.

In some variations, the one or more user devices 120 may include one or more other wireless devices. Similar to wireless devices 112-118, the one or more other wireless devices may be executing respective particular operating systems. The particular operating system may place, or enforce, one or more limits or restrictions how usage data can be viewed and/or processed by third-party applications. According to various aspects described herein, each of the one or more other wireless devices may implement software that allows for the capture of the usage data in a way that circumvents and/or avoids the one or more limits or restrictions. Further, each of the one or more other wireless devices may implement software that receives user authorization to circumvent and/or avoid the one or more limits or restrictions.

As mentioned above, the example computing environment 100 is depicted as including server 105 and/or server 106 that may perform various processes for determining network and/or application performance (e.g., determine a ranking by usage of two or more applications) and may use the usage data captured from any and/or multiple of the wireless devices as part of the various processes for determining performance of applications run on the wireless devices. As part of performing those various processes for determining application and/or network performance, the server 105 and/or server 106 may send and/or receive data communications to and/or from the various devices depicted in FIG. 1. Further, each of the wireless devices 112-118 may include a third-party application that performs various tasks associated with the processes for determining application and/or network performance, sends data to the server 105 and/or server 106, and/or receives data from the server 105 and/or server 106. In some variations, this third-party application may include one or more software components that are configured to capture of the usage data in a way that circumvents and/or avoids one or more limits or restrictions placed on usage data by an operating system of the wireless device. Further, this third-party application may include one or more software components that are configured to receive user authorization to circumvent and/or avoid the one or more limits or restrictions.

As one brief example, the usage data may be used as a way to determine the type of user. More particularly, usage data that indicates use of a video conferencing application and/or an email application may be used to determine the user type as a business user. Usage data that indicates use of a video streaming application and/or a gaming application may be used to determine the user type as a consumer.

The above discussion of FIG. 1 introduces aspects relating to how usage data is captured and how such usage data may be further analyzed and/or used. The discussion and examples of the remaining figures will provide additional details to the usage data, how the usage data is captured, and how the usage data is further analyzed and/or used. The examples described below may refer to one or more devices of example computing environment 100 depicted in FIG. 1. For example, FIG. 2 shows a block diagram of an example wireless device 201 with an operating system 210 that places one or more limits or restrictions on usage data. The example wireless device 201 of FIG. 2 may be any of the wireless devices discussed above in connection with FIG. 1 (e.g., any of wireless devices 112-118 and/or any of the one or more other wireless devices included by the one or more user devices 120).

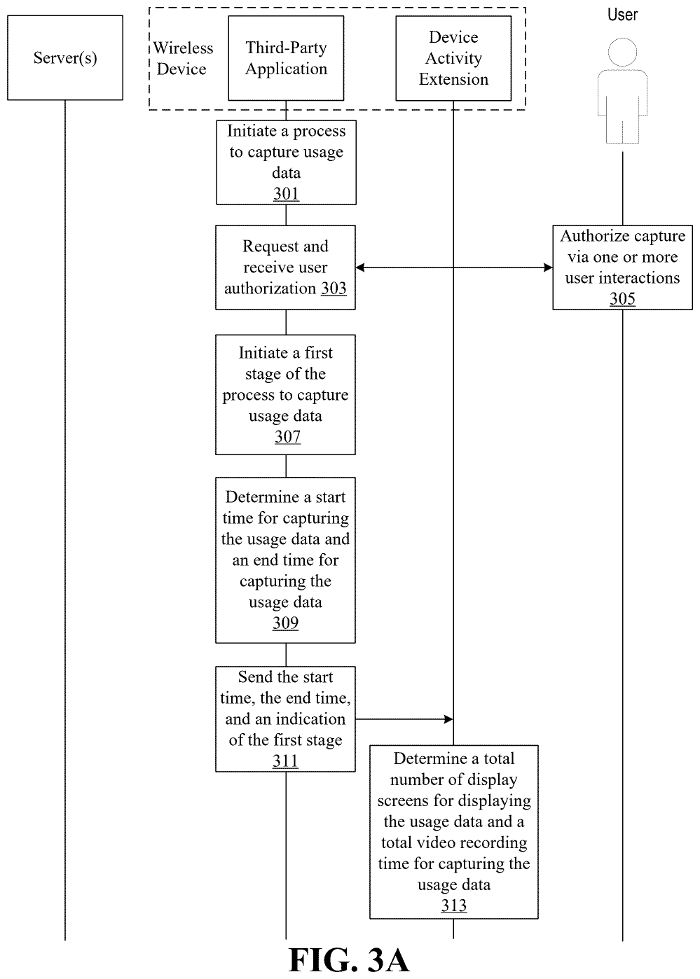

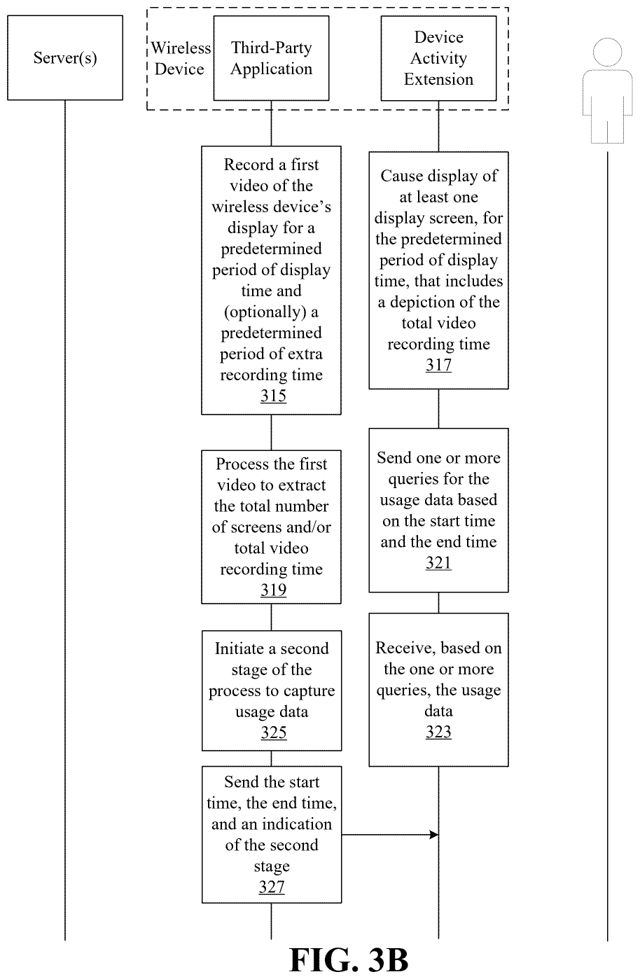

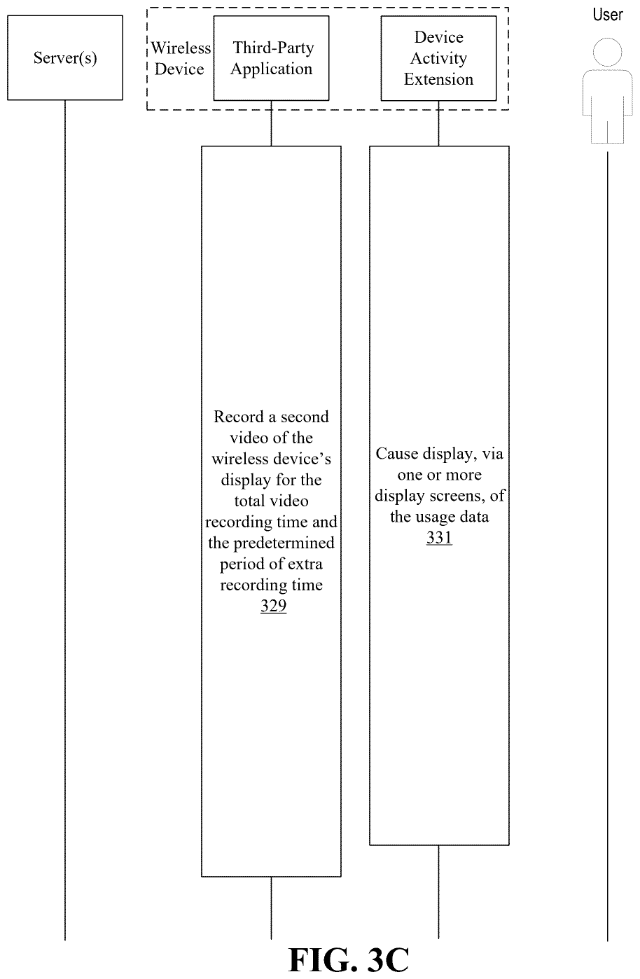

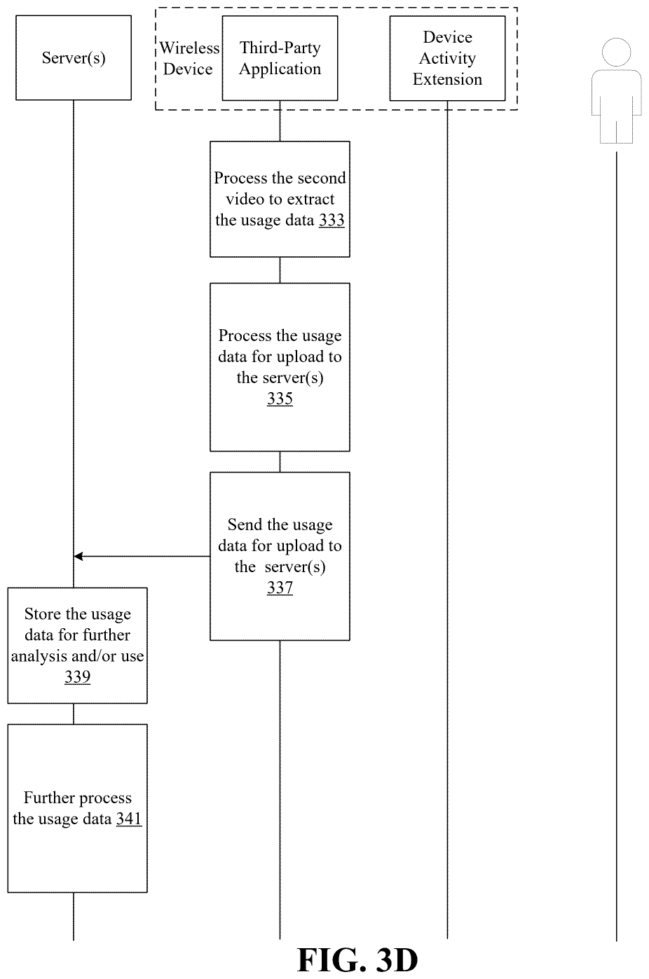

The example wireless device 201 is depicted in FIG. 2 as including a third-party application 230. Similar to the discussion of FIG. 1, the third-party application 230 may be configured to perform various tasks associated with determining network performance, configured to capture usage data in a way that circumvents and/or avoids one or more limits or restrictions placed on usage data by the operating system 210, and configured to receive user authorization, from user 203, to circumvent and/or avoid the one or more limits or restrictions. The device activity extension 250 may be another software component configured to assist in the capture of the usage data. The device activity extension 250 may be installed as part of a software package that includes the third-party application (e.g., when the user 203 chooses to download and install the third-party application 230 to the wireless device 201, the device activity extension 250 may also be downloaded and installed). In some variations, the device activity extension 250 may be configured or installed in such a way that it executes in a specific sandbox provided by the operating system 210 (e.g., device activity extension 250 is installed specifically to execute within the device activity extension sandbox 240). As used herein, a sandbox is a one or more limits and/or restrictions placed on the operation of an application. For example, a sandbox may include the operating system 210 limit an application's amount of memory usage, restrict specific areas of memory or storage, limit or restrict access to the network, input/output devices, data ports, interrupt services, or other services implemented by the device. FIGS. 3A-3D provide additional examples as to how the third-party application 230 and the device activity extension 250 may be configured to capture usage data and/or receive user authorization.

FIG. 2 provides examples of one or more limits and/or restrictions that the operating system 210, such as iOS, may place on how usage data can be viewed and/or processed by third-party applications, such as third-party application 230. The operating system 210 may execute applications and/or other software components on the wireless device 201 within their own sandbox (e.g., third-party application 230 is run within application sandbox 220 and the device activity extension 250 is run within the device activity extension sandbox 240). The operating system 210 may establish each sandbox to have its own set of limits and/or restrictions on usage data. In this way, the sandboxes of two different software components may have one or more limits and/or restrictions that differ from each other. The application sandbox 220 and the device activity extension sandbox 240 depict examples of the differences that may exist between the limits and/or restrictions on usage data of two different sandboxes. As depicted in FIG. 2 at item 222, the third-party application 230, based on the application sandbox 220, may be blocked from accessing the usage data. As depicted in FIG. 2 at item 226, the device activity extension 250, based on the device activity extension sandbox 240, may access the usage data. As depicted in FIG. 2 at item 224, the third-party application 230, based on the application sandbox 220, may be able to send data via a network and from the wireless device 201 (e.g., the third-party application 230 may be able to send data to one or more servers, such as measurement server 105 and/or ranking server 106 of FIG. 1). As depicted in FIG. 2 at item 228, the device activity extension 250, based on the device activity extension sandbox 240, may be blocked from sending data via a network, for example, by preventing extension 250 from making a network request or moving content outside of certain address space (e.g., the device activity extension 250 may be blocked from sending data to one or more servers, such as measurement server 105 and/or ranking server 106 of FIG. 1).

The example limits and/or restrictions depicted in FIG. 2 are only some of the types of limits and/or restrictions the operating system 210 may establish for sandboxes. As some examples not explicitly depicted in FIG. 2, the device activity extension 250, based on the device activity extension sandbox 240, may be allowed to receive data from other applications, such as third-party application 230. The device activity extension 250, based on the device activity extension sandbox 240, may be blocked from sending data to other applications, such as third-party application 230. Though not shown, in some variations, the third-party application 230 may not be within a sandbox and may have no restrictions on its operation.

Based on the above discussion of FIG. 2, the operating system 210 may place one or more limits and/or restrictions on how usage data can be viewed and/or processed by third-party applications. FIGS. 3A-3D, 4, and 5 provide example methods that may be used to capture usage data by circumventing or avoiding the one or more limits and/or restrictions based on user authorization. In particular, FIGS. 3A-3D, 4, and 5 provide example methods for circumventing or avoiding one or more limits and/or restrictions similar to those placed by the operating system 210. Even more specifically, FIGS. 3A-3D, 4, and 5 may be suitable for circumventing or avoiding one or more limits and/or restrictions placed by iOS or some other similar operating system.

FIGS. 3A-3D show an example flow for capturing usage data by circumventing or avoiding the one or more limits and/or restrictions based on user authorization. The example flow includes various processes and communications involving one or more servers (e.g., measurement server 105 and/or ranking server 106 of FIG. 1); a wireless device (e.g., wireless device 201 of FIG. 2, any of wireless devices 112-118 of FIG. 1, and/or any wireless device included by the one or more user devices 120 of FIG. 1); and a user (e.g., user 201 of FIG. 2). Further, the example flow depicts the wireless device as including two software components: a third-party application (e.g., third-party application 230 of FIG. 2) and a device activity extension (e.g., device activity extension 250 of FIG. 2). In this way, the various processes and communications are shown as involving those two software components of the wireless device. Moreover, the third-party application and the device activity extension may be subject to the same limits and/or restrictions on viewing and/or processing the usage data as discussed in connection with FIG. 2.

Beginning at 301 of FIG. 3A, the third-party application may initiate a process to capture usage data. This process may be initiated based on a signal received from a server (e.g., the measurement server 105 and/or ranking server 106 of FIG. 1); occurrence of an event that causes the initiation (e.g., a user opening the third-party application or pressing a button, via a user interface, that is associated with the process to capture usage data); and the like.

At 303, the third-party application may request and receive user authorization to perform the process to capture the usage data. This may take the form of the third-party application causing display of one or more user interfaces that request authorization from the user to perform the process. The user, at 305 and based on those one or more display screens, may perform one or more interactions with a user interface to provide the authorization (e.g., by pressing a button that indicates the user is giving authorization by clicking the button). In some variations, the one or more user interfaces may provide an indication of how the process to capture the usage data is performed (e.g., that video will be captured of display screens that include depictions of the usage data, that usage data within a particular period of time will be captured, and the like). Additionally, in some variations, the one or more user interfaces may indicate an incentive for the user to provide the authorization (e.g., the user may receive an amount of money, a coupon, or the like for authorizing the capture of the usage data). Further, in some variations, the one or more user interfaces may allow a user to input or modify an authorized period of time for capturing the usage data. In this way, the user may be able to limit the capture to only usage data that falls within the authorized period of time (e.g., if the authorized period of time is two months, the only usage data that will be captured will be usage data that falls within the most recent two months).

In some variations, once the user authorization is received by the third-party application, the remaining steps of the example flow that are performed by the third-party application and the device activity extension (e.g., 307-337 of FIGS. 3A-3D) may be performed in an automated fashion and/or without further user input. In particular, the first stage and the second stage may both proceed in an automated fashion and/or without further user input. In these variations, for example, the user may be able to view changes to the display of the wireless device as the third-party application and the device activity extension proceed through the remaining steps of the example flow, but may not be able to interrupt the process until the usage data is sent from the wireless device or stored in an accessible memory in the wireless device at 337 of FIG. 3D.

At 307, the third-party application may, based on the user authorization, initiate a first stage of the process to capture the usage data. In general, the first stage may be performed to communicate one or more criteria for the capture of the usage data between the third-party application and the device activity extension. The example flow of FIG. 3A depicts criteria, such as a start time and an end time for capturing the usage data, being communicated from the third-party application and to the device activity extension via the sending at 311. Other criteria may include specifying specific categories of application usage, such as gaming, health monitoring, etc. The example flow of FIG. 3A further depicts criteria, such as a total number of screens for displaying usage data or total video recording time for capturing the usage data, being communicated from the device activity extension and to the third-party application via the recording at 315 and the displaying at 317. Further, the first stage is depicted in FIGS. 3A-3B as occurring from 309 to 319.

At 309, the third-party application may determine a start time for capturing the usage data and an end time for capturing the usage data. The start time and the end time may indicate bounds for what usage data will be displayed during the second stage of the process to capture the usage data. For example, any usage data that falls outside the bounds indicated by the start time and the end time may not be displayed and, thus, not captured by this process. Any usage data that falls inside the bounds indicated by the start time and the end time may be displayed and, thus, captured by this process. For example, if the start time indicates Jun. 1, 2023 at 12:00 AM, usage data for any usage that occurred before Jun. 1, 2023 at 12:00 AM may not be displayed and, thus, not captured by this process (e.g., usage occurring in May 2023 may not be displayed nor captured). If the end time indicates Jul. 31, 2023 at 11:59 PM, usage data for any usage that occurred after Jul. 31, 2023 at 11:59 PM may not be displayed and, thus, not captured by this process (e.g., usage occurring in August 2023 may not be displayed nor captured). For those same start and end times, usage data for any usage that occurred between Jun. 1, 2023 at 12:00 AM and Jul. 31, 2023 at 11:59 PM may be displayed and, thus, captured. In some variations, the start time and the end time may be based on a pre-configured period of time stored by the third-party application (e.g., the third-party application may store a setting that indicates to always collect usage data over the last three months). In other variations, the start time and end time may be based on an indication received by the third-party application from a server (e.g., the measurement server 105 and/or ranking server 106 of FIG. 1 may send a request the capture of usage data over a particular period of time). In yet other variations, the start time and end time may be based on the authorized period of time that was input or modified by the user. In other variations, a combination of start time and duration or a combination of end time and duration may be used to indicate the bounds of the usage data.

After determining the start time and/or the end time and/or the recording duration, the third-party application may, at 311, send, to the device activity extension, the start time, the end time, and/or recording duration, and an indication of the first stage. The indication of the first stage may indicate to the device activity extension that the process for capturing the usage data is in the first stage (e.g., the numeric value of 1 may indicate the process is in first stage or the Boolean value of 0 may indicate the process is in the first stage).

At 313, based on receiving the start time, end time, and the indication of the first stage, the device activity extension may determine a total number of display screens for displaying the usage data and a total video recording time for capturing the usage data. The total number of display screens for displaying the usage data may indicate the number of display screens that will be displayed in the second stage. The total number of display screens may be determined based on the start time and the end time. For example, a longer period of time (e.g., three months) defined by the start time and the end time may require a greater number of display screens than if a shorter period of time (e.g., one day) was defined by the start time and the end time. Further, the total number of display screens may be determined based on how the operating system collects, accumulates, and/or presents the usage data. For example, if the operating system collects, accumulates, and/or presents the usage data in a finer granularity (e.g., hour by hour as opposed to month by month), the total number of display screens may be greater. Even further, the total number of display screens may be determined based on an application programming interface (API), provided by the operating system of the wireless device, that allows the device activity extension to query for the usage data. For example, if the operating system provides an API that provides the usage data in certain formats, the formats may affect the total number of display screens. The number of display screens may further depend on the resolution of the display, where more information can be displayed on a higher resolution screen and less information can be displayed on a lower resolution screen, thus requiring less and more display screens respectively.

For example, an API that provides the usage data as text, with hour-by-hour granularity for a three-month period of application usage may use 10 display screens to display all of the usage data. In another example, the API that presents the same three months of usage as a bar chart, with each month's usage represented by a single bar may use only one display screen to display the usage data. Another example includes presenting the usage data encoded as a QR code instead of text.

The total number of display screens for displaying the usage data may indicate the total video recording time for capturing the usage data. This may be determined by multiplying the total number of display screens by a display time for a single display screen. For example, if the total number of display screens is 6 and the display time for a single display screen is 5 seconds, the total video recording time may be 30 seconds. In some variations, both the third-party application and the device activity extension are preconfigured with the display time (e.g., 100 ms) for a single display screen. In others, the device activity extension is preconfigured with the display time for a single display screen (e.g., 100 ms).

Continuing at 315 of FIG. 3B, the third-party application may record a first video of the wireless device's display. This first video may be recorded for a predetermined period of display time and (optionally) a predetermined period of extra recording time. The predetermined period of display time may provide a known period of time (e.g., 4 seconds) that the device activity extension will cause display of at least one display screen that includes a depiction of the total of number of display screens and/or a total video recording time used to display the usage data. Put another way, by recording for the predetermined period of display time, the first video may include video data for a known period of time (e.g., 4 seconds) that the device activity extension will cause display of at least one display screen that includes a depiction (e.g., text) indicating the total number of display screens or total video recording time. The predetermined period of display time may be preconfigured in, or otherwise known by, both the third-party application and the device activity extension. The predetermined period of extra recording time (e.g., 2 seconds) may provide a buffer of extra video to ensure the first video includes the at least one display screen that is displayed at 317. By recording for the predetermined period of extra recording time (e.g., 2 seconds), the first video may include video data that provides a buffer of extra time as a way to ensure the first video includes the at least one display screen.

At 317, the device activity extension may cause display of at least one display screen. The at least one display screen may be displayed for a time, for example, equal to the predetermined period of display time. The at least one display screen may include a depiction of the total number of screens for displaying usage data (e.g., a display screen that presents the text “4” or “four” to indicate four display screens) and/or a depiction of the total video recording time (e.g., a display screen that includes the text “30 seconds” to indicate a total video recording time of 30 seconds). The at least one display screen may include one or more depictions of additional information being communicated from the device activity extension to the third-party application. For example, the at least one display screen may include a depiction of the display time for a single display screen.

The depiction of FIG. 3B illustrates the relationship between how long the device activity extension displays the at least one display screen at 317 and how long the third-party application records the first video at 315. In particular, the length of the box for recording the first video at 315 is longer than the length of the box for causing display of the at least one display screen at 317. This is because the third-party application records the first video for equal to or longer than the device activity extension causes display of the at least one display screen. Indeed, as mentioned above at 315, the third-party application may also record for a predetermined period of extra recording time and this is reflected by the lengths of the boxes at 315 and 317.

At 319, the third-party application may process the first video to extract the total video recording time from the at least one display screen. This extraction may include performing optical character recognition (OCR) on the at least one display screen recorded by the first video and identifying the total number of display screens and/or total video recording time from the results of the OCR process. The third-party application may also extract additional information from the at least one display screen. For example, the at least one display screen may include a depiction of the display time for a single display screen, and the third-party application may extract the display time for a single display screen similar from the at least one display screen (e.g., identify the total number of display screens or total display time from results of the OCR process). In some variations, the third-party application may determine additional information based on information extracted from the at least one display screen. For example, if the third-party application extracts a total video recording time and a total number of display screens from the at least one display screen, the third-party application may determine the display time for a single display screen by dividing the total video recording time by the total number of display screens (e.g., dividing 30 seconds by 6 total display screens results in the display time for a single display screen being 5 seconds). Amongst the total number of screens, the total display time, and the display time per screen, extracting any two of these from at least one display screen may be used to determine the third.

At 321, the display activity extension may send one or more queries for the usage data based on the start time and/or the end time and/or duration. The one or more queries may be based on the API provided by the operating system that allows access to the usage data. The one or more queries may be based on the start time and the end time such that any response to the one or more queries includes usage data that falls inside the bounds indicated by the start time and the end time.

At 323, the display activity extension may receive, based on the one or more queries, the usage data. This usage data may have been gathered and provided by the operating system of the wireless device in response to the one or more queries. Because the one or more queries were based on the start time and the end time, the operating system may respond to those queries with any usage data that falls inside the bounds indicated by the start time and the end time. In this way, the usage data received at 323 is also based on the start time and the end time.

While the sending of the one or more queries and the receiving of the usage data at, respectively, 321 and 323 are shown as occurring in parallel to portions of 315, 319, 325, and 327, the sending of the one or more queries and the receiving of the usage data may occur at any time between the device activity extension completing display of the at least one display at 317 of FIG. 3B and causing display of the usage data at 327 of FIG. 3C. Put another way, the sending of the one or more queries and the receiving of the usage data at, respectively 321 and 323, represent steps that the device activity extension may perform in preparation to performing the second stage of the process to capture the usage data. Additionally, while the sending of the one or more queries at 321 is shown as occurring before the receiving of the usage data at 323, this order is shown for simplicity. In some variations the device activity extension, at 321 and 323, may be performing an iterative process that queries for and receives the usage data. As one example of an iterative process that queries for and receives the usage data, a first query may be sent for a first portion of the usage data and a first response may be received that is responsive to the first query. The first portion may be based on a first range of time within the bounds indicated by the start time and end time (e.g., the first day of usage data within the bounds indicated by the start time and end time). Following that first response, a second query may be sent for a second portion of the usage data and a second response may be received that is responsive to the second request. The second portion may be based on a second range of time within the bounds indicated by the start time and end time (e.g., the second day of usage data within the bounds indicated by the start time and end time). This iterative process may be repeated until all portions of the usage data have been received.

At 325, the third-party application may initiate a second stage of the process to capture the usage data. In general, the second stage may be performed to capture the usage data based on the one or more criteria communicated between the third-party application and the device activity extension during the first stage. The second stage is depicted in FIGS. 3B-3D as occurring from 327 to 337.

As depicted at 327, the third-party application may send the start time, the end time, and/or duration, and an indication of the second stage. The indication of the second stage may indicate to the device activity extension that the process for capturing the usage data is in the second stage (e.g., the numeric value of 2 may indicate the second stage or the Boolean value of 1 may indicate the second stage).

Continuing at 329 of FIG. 3C, the third-party application may record a second video of the wireless device's display. This second video may be recorded for the total video recording time and the predetermined period of extra recording time. Put another way, by recording for the total video recording time, the second video may include video data for a known period of time (e.g., 30 seconds) that the device activity extension will cause display of one or more display screens that include one or more depictions of the usage data. The total video recording time (e.g., 30 seconds) may be part of the information extracted from the first video at 319. The predetermined period of extra recording time (e.g., 2 seconds) may provide a buffer of extra video to ensure the second video includes the one or more display screens displayed at 331. Put another way, by recording for the predetermined period of extra recording time (e.g., 2 seconds), the second video may include video data that provides a buffer of extra time as a way to ensure the second video includes the one or more display screens.

At 331, the device activity extension may cause display of one or more display screens. The one or more display screens may be displayed for a time equal to the total video recording time. The display of the one or more display screens may be based on the usage data queried for at 321 and received at 323. More particularly, the one or more display screens may include one or more depictions of usage data that falls inside the bounds indicated by the start time and the end time. The one or more display screens may not include any depiction of usage data that falls outside the bounds indicated by the start time and the end time. Each of one or more display screens may include one or more depictions of a portion of the usage data that falls inside the bounds indicated by the start time and the end time (e.g., a first display screen may include a first portion of the usage data for a first week, and a second display screen may include a second portion of the usage data for a second week, and so forth). Each of the one or more depictions may take the form of text that indicates the portion of the usage data that falls inside the bounds indicated by the start time and the end time.

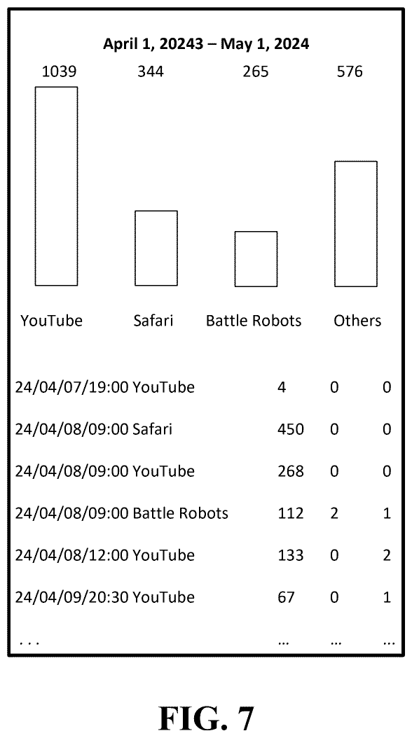

In some variations, the one or more depictions may be a processed version of the usage data. For example, to improve privacy of the usage data, the one or more depictions may take the form of a quick-response (QR) code that encodes the usage data, or a portion thereof, into a two-dimensional matrix barcode. In such variations, the device activity extension may include a QR code generator for encoding the usage data, or portions thereof, into the two-dimensional matrix barcode. As another example, to improve a user's experience when the usage data is being displayed, the one or more depictions may take the form of a stylized animation that combines depictions of the usage data, or portions thereof, with graphical renderings, graphs, animations, or other visual effects. In some operating system environments, the exact form of the processed version may depend on how the operating system limits or restricts displays of the usage data. FIG. 7 illustrates an example of a display of the usage data by the device activity extension 250. At the top of the display is a date range (e.g., Apr. 1, 2024-May 1, 2024) indicating the start time and end time for capturing usage data. Below the date range, a graphic that summarizes certain usage data over the time period. For example, a bar chart may be illustrated that shows usage (for example, counted in minutes) of the three most used applications (e.g., “YouTube,” “Safari,” “Battle Robots”) over the time period. A forth bar may show the usage of all other applications combined (e.g., “Others”). Below the summary graphic, individual records of usage data as captured by device activity extension 250 is displayed. Each entry may include a data/time stamp (e.g., “24/04/08/09:00” representing Apr. 7, 2024 at 09:00 a.m.) indicating a start time or end time of when the data was captured, an application (e.g., “Battle Robots”), and/or one or more numbers (e.g., “112 2 1”) representing data usage metrics for that the identified application. For example, a first number (e.g., “112”) may indicate the total number of minutes the application was running in the foreground (e.g., displayed on the device display), a second number (e.g., “2”) may represent a number of notifications to the user initiated by the application, and a third number (e.g., “1”) may represent a number of times the user launched or selected the application to run in the foreground or responded to a notification. Depending on the number of individual records to display, the device in step 331 may switch display screens to present a different set of records, for example, by scrolling the records vertically in the lower part of the window, or displaying a different set of records (e.g., periodically, every 100 ms), which may then be recorded in step 329.

The depiction of FIG. 3C illustrates the relationship between how long the device activity extension displays the one or more display screens at 331 and how long the third-party application records the second video at 329. In particular, the length of the box for recording the second video at 329 is longer than the length of the box for causing display of the one or more display screens at 331. This is because the third-party application records the second video for equal or longer than the device activity extension causes display of the one or more display screens. Indeed, as mentioned above at 329, the third-party application also records for a predetermined period of extra recording time and this is reflected by the lengths of the boxes at 329 and 331. The depictions of FIGS. 3B and 3C also show a potential relationship between the lengths of the first video and the second video. As depicted in FIGS. 3B and 3C, the length of the second video may be much longer (e.g., 500 milliseconds) than the length of the first video (e.g., 100 milliseconds).

Continuing at 333 of FIG. 3D, the third-party application may process the second video to extract the usage data. This extraction may include performing optical character recognition (OCR) on the one or more display screens recorded by the second video and identifying the usage data from the results of the OCR process. In some variations, processing the second video may include extracting the one or more display screens from the second video. Extracting the one or more display screens may be based on a key-frame extraction method that detects key frames based on transition detection and/or image entropy. After the one or more display screens have been extracted from the second video, the OCR process may be performed on the one or more display screens and the usage data may be identified from the results of the OCR process.

At 335, the third-party application may process the usage data for upload to the one or more servers. This may include encrypting the usage data and/or otherwise preparing the usage data for transport via one or more networks. Once encrypted and/or otherwise prepared for transport via one or more networks, the third-party application, at 337, may send the usage data for upload to the one or more servers.

At 339, the one or more servers may store the usage data for further analysis and/or use. The example depicted in FIG. 3D provides one example of further analysis and/or use. Indeed, at 341, the one or more servers may further process the usage data as part of a process to evaluate and improve the performance of certain applications. For example, usage data may indicate which features of a certain application do not get used often, and may be eliminated. As another example, usage data may be used to detect, evaluate, and/or optimize power consumption, memory usage, and stability of an application run on different wireless devices and/or in different configurations and/or with different operating system versions. As another example, the usage data may be used as a basis for determining one or more questions included in a survey to the user of the wireless device. The usage data may be used as a basis for determining a ranking of two or more wireless networks based on different applications usage of those networks via the wireless device (e.g., as discussed above with respect to FIG. 1). The usage data may be used as a way to determine the type of user.

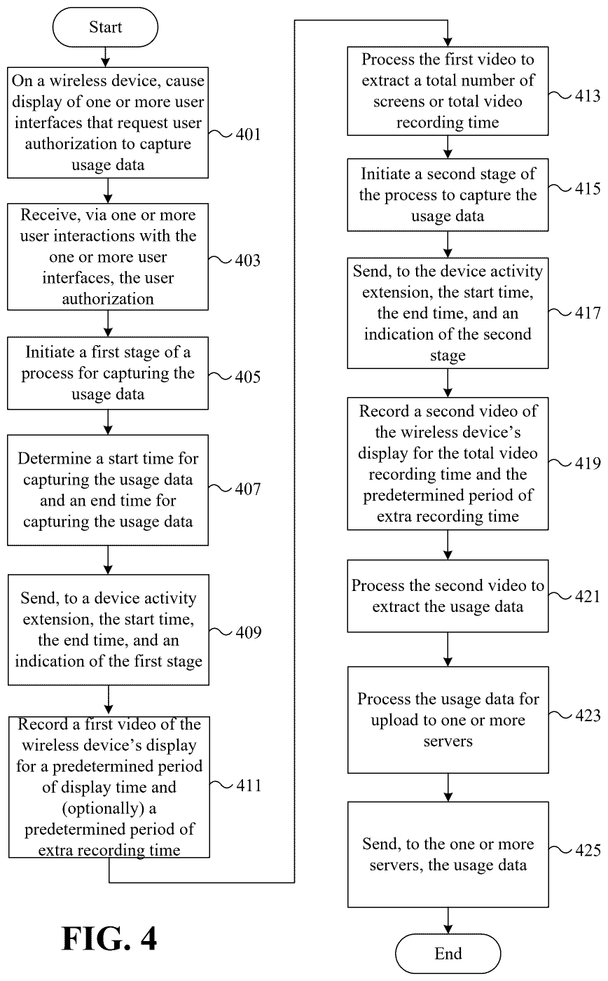

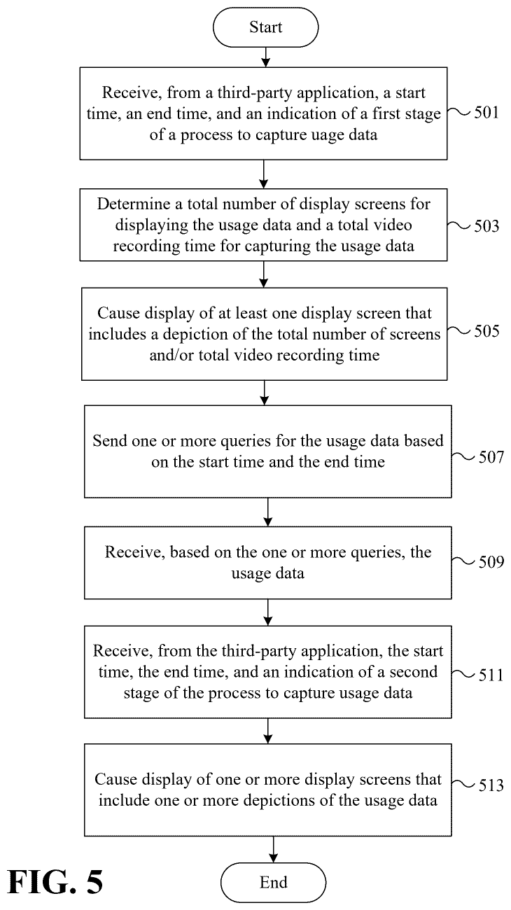

The above example flow of FIGS. 3A-3D provides a number of examples of the way usage data can be captured by circumventing or avoiding one or more limits and/or restrictions placed on usage data by an operating system of a wireless device. FIGS. 4 and 5 provide examples of methods that may be performed by the wireless device, and the software components (e.g., the third-party application and the device activity extension), discussed in connection with the example flow of FIGS. 3A-2D.

FIG. 4 shows an example method that records video so that, in accordance with various aspects described herein, usage data can be captured based on the video. This method may be performed by a third-party application (e.g., third party-application 230 of FIG. 2) of a wireless device.

At step 401, the third-party application may cause display of one or more user interfaces that request user authorization to capture usage data. The one or more user interfaces may be the same as, or similar to, those discussed above at 303 of FIG. 3A. For example, the one or more user interfaces may include user interface widgets in association with requesting the user authorization (e.g., a button that, if pressed, indicates the user is giving authorization to capture the usage data). The one or more user interfaces may provide an indication of how the process to capture the usage data is performed. The one or more user interfaces may allow a user to input or modify an authorized period of time for capturing the usage data. In this way, the user may be able to limit the capture to only usage data that falls within the authorized period of time.

At step 403, the third-party application may receive, via one or more user interactions with the one or more user interfaces, the user authorization. The one or more user interactions may be the same as, or similar to, those discussed above at 303 of FIG. 3A. For example, the user may press a button that indicates the user is giving authorization to capture the usage data.

At step 405, the third-party application may, based on the user authorization, initiate a first stage of a process for capturing the usage data. The first stage may be the same as or similar to the first stage discussed at 307 of FIG. 3A. In general, the first stage may be performed to communicate one or more criteria for the capture of the usage data between the third-party application and the device activity extension. The example method of FIG. 4 depicts example criteria such as a start time, an end time, and a total video recording time. For the example method of FIG. 4, the first stage includes steps 407-413.

At step 407, the third-party application may determine a start time for capturing the usage data and an end time for capturing the usage data. This determination may be performed the same as, or similar to, the determination discussed above at 309 of FIG. 3A. For example, the start time and the end time may indicate bounds for displaying the usage data during the second stage of the process to capture the usage data. For example, any usage data that falls outside the bounds indicated by the start time and the end time may not be displayed and, thus, not captured by this process. Any usage data that falls inside the bounds indicated by the start time and the end time may be displayed and, thus, captured by this process. In some variations, the start time and the end time may be based on a pre-configured period of time stored by the third-party application. In other variations, the start time and end time may be based on an indication received by the third-party application from a server. In yet other variations, the start time and end time may be based on the authorized period of time that was input or modified by the user.

At step 409, the third-party application may send, to a device activity extension of the wireless device, the start time, the end time, and/or time period, and an indication of the first stage. The indication of the first stage may be the same as, or similar to, the indication of the first stage discussed at 311 of FIG. 3A. For example, the indication of the first stage may indicate to the device activity extension that the process for capturing the usage data is in the first stage.

While step 409 illustrates an example where the third-party application communicates criteria such as the start time, the end time, and an indication of the first stage to the device activity extension, other variations may communicate different, additional, or a subset of the criteria sent at step 409. For example, in some variations, the third-party application may communicate the start time and the end, but may exclude the indication of the first stage. In such variations, the sending may be performed based on an API call for the first stage and/or the device activity extension may identify that the process for capturing the usage data is in the first stage based on the inclusion of the start time and the end time.

At step 411, the third-party application may record a first video of the wireless device's display for a predetermined period of display time and a predetermined period of extra recording time. This recording may be performed the same as, or similar to, the recording discussed above at 315 of FIG. 3B. For example, by recording for the predetermined period of display time, the first video may include video data for a known period of time (e.g., 4 seconds) that the device activity extension will cause display of at least one display screen that includes a depiction of the total video recording time. By recording for the predetermined period of extra recording time (e.g., 2 seconds), the first video may include video data that provides a buffer of extra time as a way to ensure the first video includes the at least one display screen.

At step 413, the third-party application may process the first video to extract a total number of display screens and/or a total video recording time. This extraction may be performed the same as, or similar to, the extraction discussed above at 317. For example, this extraction may include performing optical character recognition (OCR) on the at least one display screen recorded by the first video and identifying the total video recording time from the results of the OCR process.

At step 415, the third-party application may initiate a second stage of the process to capture the usage data. This second stage may the same as, or similar to, the second stage discussed above at 325 of FIG. 3B. For example, in general, the second stage may be performed to capture the usage data based on the one or more criteria communicated between the third-party application and the device activity extension during the first stage. For the example method of FIG. 4, the second stage includes steps 417-425.

At step 417, the third-party application may send, to the device activity extension, the start time, the end time, and an indication of the second stage. The indication of the second stage may be the same as, or similar to, the indication of the second stage discussed above at 327. For example, the indication of the second stage may indicate to the device activity extension that the process for capturing the usage data is in the second stage.

While step 417 illustrates an example where the third-party application communicates criteria such as the start time, the end time, and an indication of the first stage to the device activity extension, other variations may communicate different, additional, or a subset of the criteria sent at step 417. For example, in some variations, the third-party application may communicate the indication of the second stage, but may exclude the start time and the end time. In such variations, the sending may be performed based on an API call for the second stage and/or the third-party application may have already communicated the start time and the end time to the device activity extension in a prior communication. In yet other variations, the sending at step 417 may not be performed. Instead, in such variations, the third-party application may proceed to step 419 directly after initiating the second stage at step 415.

At step 419, the third-party application may record a second video of the wireless device's display for the total video recording time and the predetermined period of extra recording time. This recording may be performed the same as, or similar to, the recording discussed above at 329 of FIG. 3C. For example, by recording for the total video recording time, the second video may include video data for a known period of time (e.g., 30 seconds) that the device activity extension will cause display of one or more display screens that include one or more depictions of the usage data. By recording for the predetermined period of extra recording time (e.g., 2 seconds), the second video may include video data that provides a buffer of extra time as a way to ensure the second video includes the one or more display screens.

At step 421, the third-party application may process the second video to extract the usage data. This extraction may be performed the same as, or similar to, the extraction discussed at 333 of FIG. 3D. For example, this extraction may include performing optical character recognition (OCR) on the one or more display screens recorded by the second video and identifying the usage data from the results of the OCR process.

At step 423, the third-party application may process the usage data for upload to one or more servers. This processing may be performed the same as, or similar to, the processing discussed above at 335 of FIG. 3D. For example, this processing may include encrypting the usage data and/or otherwise preparing the usage data for transport via one or more networks.

At step 425, the third-party application may send the usage data to the one or more servers. In some variations, the one or more servers may perform, or be otherwise associated with, various processes for evaluating and improving the performance of certain applications, evaluating network usage by the applications, and/or evaluating a user's habits in using the applications. Upon receiving the usage data, the one or more servers may decrypt the usage data, store the usage data, and further analyze and/or use the usage data (e.g., use the usage data as part of a process for determining wireless network performance). The further analysis and/or further use of the usage data may be the same as, or similar to, the analyses and/or uses discussed at 341 of FIG. 3D.

In some variations, once the user authorization is received by the third-party application at step 403, the remaining steps of the example method of FIG. 4 may be performed by the third-party application in an automated fashion and/or without further user input. In particular, the first stage and the second stage may both proceed in an automated fashion and/or without further user input. In these variations, for example, the user may be able to view the display of the wireless device as the third-party application records the first video and the second video at, respectively, steps 411 and 419, but may not be able to interrupt the process until the usage data is sent from the wireless device at step 425.

FIG. 5 shows an example method for displaying one or more display screens that depict the wireless device usage data so that, in accordance with various aspects described herein, wireless device usage data can be captured based on the one or more display screens. This method may be performed by a device activity extension (e.g., device activity extension 250 of FIG. 2) of a wireless device.

At step 501, the device activity extension may receive, from a third-party application, a start time, an end time, and an indication of a first stage of a process to capture usage data. The start time, the end time, and the indication of the first stage may be the same as, or similar to, those discussed above at 311 of FIG. 3A. Further, the start time, the end time, and the indication of the first stage may be the same as those sent at step 409 of FIG. 4. For the example method of FIG. 5, the first stage may include steps 503-507.

While step 501 illustrates an example where the device activity extension receives criteria such as the start time, the end time, and an indication of the first stage from the third-party application, other variations may receive different, additional, or a subset of the criteria received at step 501. For example, in some variations, the device activity extension may receive the start time and the end, but may not receive the indication of the first stage. In such variations, the receiving may be performed based on an API call for the first stage and/or the device activity extension may identify that the process for capturing the usage data is in the first stage based on the inclusion of the start time and the end time.

At step 503, the device activity extension may determine a total video recording time for capturing the usage data. This determination may be performed the same as, or similar to, the determination discussed above at 313 of FIG. 3A. For example, the total number of display screens for displaying the usage data may indicate the number of display screens that will be displayed in the second stage. The total number of display screens may be determined based on the start time and the end time. The total video recording time for capturing the usage data may indicate the number seconds for displaying the total number of display screens. The total video recording time may be determined by multiplying the total number of display screens by a display time for a single display screen.

At step 505, the device activity extension may cause display of at least one display screen that includes a depiction of the total number of display screens and/or total video recording time. This displaying of the at least one display screen may be performed the same as, or similar to, the display discussed above at 317. For example, the at least one display screen may be displayed for a time equal to the predetermined period of display time. The depiction of the total number of display screens and/or total video recording time may take the form of text (e.g., the at least one display screen may include text of “5 screens” or “30 seconds”).

At step 507, the device activity extension may send one or more queries for the usage data based on the start time and the end time. The sending of the one or more queries may be performed the same as, or similar to, the sending discussed above at 321 of FIG. 3B. For example, the one or more queries may be based on the API provided by the operating system that allows access to the usage data. The one or more queries may be based on the start time and the end time such that any response to the one or more queries includes usage data that falls inside the bounds indicated by the start time and the end time. The sending of the one or more queries may be performed as part of an iterative process that queries for and receives the usage data. The sending of the one or more queries may represent one of the steps that the device activity extension may perform in preparation to performing the second stage of the process to capture the usage data.

At step 509, the device activity extension may receive, based on the one or more queries, the usage data. The receiving of the usage data may be performed the same as, or similar to, the receiving discussed above at 323 of FIG. 3B. For example, the usage data may have been gathered and provided by the operating system of the wireless device in response to the one or more queries. Because the one or more queries were based on the start time and the end time, the operating system may respond to those queries with any usage data that falls inside the bounds indicated by the start time and the end time. In this way, the usage data received at step 509 may also be based on the start time and the end time. The receiving of the usage data may be performed as part of an iterative process that queries for and receives the usage data. The receiving of the usage data may represent one of the steps that the device activity extension may perform in preparation to performing the second stage of the process to capture the usage data.

At step 511, the device activity extension may receive, from the third-party application, the start time, the end time, and an indication of a second stage of the process to capture usage data. The indication of the second stage may be the same as, or similar to, the indication of the second stage discussed above at 327 of FIG. 3B. Further, the start time, the end time, and the indication of the first stage may be the same as those sent at step 417 of FIG. 4. For the example method of FIG. 5, the second stage may include step 513.

While step 511 illustrates an example where the device activity extension receives criteria such as the indication of the second stage from the third-party application, other variations may receive different, additional, or a subset of the criteria received at step 511. For example, in some variations, the device activity extension may receive the indication of the second stage, but may not receive the start time and the end time. In such variations, the receiving may be performed based on an API call for the second stage and/or the device activity extension may have already received the start time and the end time in a prior communication. In yet other variations, the receiving at step 511 may not be performed. Instead, in such variations, the device activity extension may proceed to step 513 after receiving the usage data at step 509.

At step 513, the device activity extension may cause display of one or more display screens that include one or more depictions of the usage data. This displaying of the one or more display screens may be performed the same as, or similar to, the displaying discussed at 331 of FIG. 3C. The one or more display screens may be displayed for a time equal to the total video recording time. The one or more display screens may include one or more depictions any usage data that falls inside the bounds indicated by the start time and the end time. The one or more display screens may not include any depictions for usage data that falls outside the bounds indicated by the start time and the end time. Each of one or more display screens may include one or more depictions of a portion of the usage data that falls inside the bounds indicated by the start time and the end time.

In some variations, because the user authorization is received by the third-party application before the first stage is initiated with the device activity extension, the steps of the example method of FIG. 5 may be performed by the device activity extension in an automated fashion and/or without further user input. In particular, the first stage and the second stage may both proceed in an automated fashion and/or without further user input. In these variations, for example, the user may be able to view the display of the wireless device as the device activity extension causes display of the at least one display screen at step 505 and the one or more display screens at step 513, but may not be able to interrupt the process.

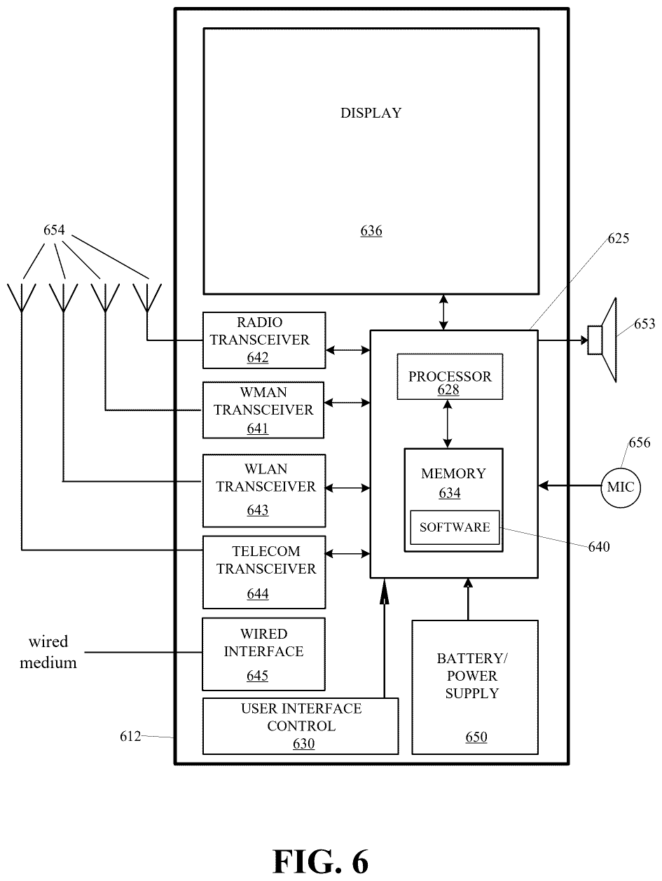

Any of the method steps, operations, procedures or functions described herein may be implemented using one or more processors and/or one or more memory in combination with computer executable instructions that cause the one or more processors and other components to perform various method steps, described features, or other aspect described herein. FIG. 6 illustrates an example apparatus, in particular a computing device 612, that may be used in a communication network such as the one shown in FIG. 1 or as the wireless device 201 shown in FIG. 2. The computing device 612 may be used to implement any or all of the devices, servers and other equipment to perform the steps described above and in FIGS. 2, 3A-3D, 4, and 5. Computing device 612 may include a controller 625. The controller 625 may be connected to a user interface control 630, display 636 and/or other elements as shown. Controller 625 may include circuitry, such as for example one or more processors 628 and one or more memory 634 storing software 640 (e.g., computer executable instructions). The software 640 may comprise, for example, one or more of the following software options: user interface software, server software, etc., including a radio protocol stack, etc.

Device 612 may also include a battery 650 or other power supply device, speaker 653, and one or more antennae 654. Device 612 may include user interface circuitry, such as user interface control 630. User interface control 630 may include controllers or adapters, and other circuitry, configured to receive input from or provide output to a keypad, touch screen, voice interface—for example via microphone 656, function keys, joystick, data glove, mouse and the like. The user interface circuitry and user interface software may be configured to facilitate user control of at least some functions of device 612 though use of a display 636. Display 636 may be configured to display at least a portion of a user interface of device 612. Additionally, the display may be configured to facilitate user control of at least some functions of the device (for example, display 636 could be a touch screen).

Software 640 may be stored within memory 634 to provide instructions to processor 628 such that when the instructions are executed, processor 628, device 612 and/or other components of device 612 are caused to perform various functions or methods such as those described herein (for example, as depicted in FIGS. 3A-3D, 4, and 5). The software may comprise machine executable instructions and data used by processor 628 and other components of computing device 612 and may be stored in a storage facility such as memory 634 and/or in hardware logic in an integrated circuit, ASIC, etc. Software may include both applications and/or services and operating system software, and may include code segments, instructions, applets, pre-compiled code, compiled code, computer programs, program modules, engines, program logic, and combinations thereof.

Memory 634 may include any of various types of tangible machine-readable storage medium, including one or more of the following types of storage devices: read only memory (ROM) modules, random access memory (RAM) modules, magnetic tape, magnetic discs (for example, a fixed hard disk drive or a removable floppy disk), optical disk (for example, a CD-ROM disc, a CD-RW disc, a DVD disc), flash memory, and EEPROM memory. As used herein, a tangible or non-transitory machine-readable storage medium is a physical structure that may be touched by a human. A signal would not by itself constitute a tangible or non-transitory machine-readable storage medium, although other embodiments may include signals or ephemeral versions of instructions executable by one or more processors to carry out one or more of the operations described herein.

As used herein, processor 628 (and any other processor or computer described herein) may include any of various types of processors whether used alone or in combination with executable instructions stored in a memory or other computer-readable storage medium. Processors should be understood to encompass any of various types of computing structures including, but not limited to, one or more microprocessors, special-purpose computer chips, field-programmable gate arrays (FPGAs), controllers, application-specific integrated circuits (ASICs), hardware accelerators, digital signal processors, software defined radio components, combinations of hardware/firmware/software, or other special or general-purpose processing circuitry.

As used in this application, the term “circuitry” may refer to any of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone, server, or other computing device, to perform various functions) and (c) circuits, such as a microprocessor(s) or a portion of a microprocessor(s), that require software or firmware for operation, even if the software or firmware is not physically present.

These examples of “circuitry” apply to all uses of this term in this application. As an example, as used in this application, the term “circuitry” would also cover an implementation of merely a processor (or multiple processors) or portion of a processor and its (or their) accompanying software and/or firmware. The term “circuitry” would also cover, for example, a radio frequency circuit, a baseband integrated circuit or applications processor integrated circuit for a mobile phone or a similar integrated circuit in a server, a cellular network device, or other network device.

Device 612 or its various components may be mobile and be configured to receive, decode and process various types of transmissions including transmissions in Wi-Fi networks according to a wireless local area network (e.g., the IEEE 802.11 WLAN standards 802.11n, 802.11ac, etc.) and/or wireless metro area network (WMAN) standards (e.g., 802.16), through a specific one or more WLAN transceivers 643, one or more WMAN transceivers 641. Additionally or alternatively, device 612 may be configured to receive, decode and process transmissions through various other transceivers, such as FM/AM Radio transceiver 642, and telecommunications transceiver 644 (e.g., cellular network receiver such as CDMA, GSM, 4G LTE, 5G, etc.). A wired interface 645 (e.g., an Ethernet interface) may be configured to provide communication via a wired communication medium (e.g., fiber, cable, Ethernet, etc.).

Although the above description of FIG. 6 generally relates to a mobile device, other devices or systems may include the same or similar components and perform the same or similar functions and methods. For example, a computer communicating over a wired network connection may include the components or a subset of the components described above, and may be configured to perform the same or similar functions as device 612 and its components. Further base stations or access points as described herein may include the components, a subset of the components, or a multiple of the components (e.g., integrated in one or more servers) configured to perform one or more aspects described herein.

Although specific examples of carrying out the invention have been described, there are numerous variations and permutations of the above-described systems and methods that are contained within the spirit and scope of the invention as set forth in the appended claims.

We claim:

1. A method comprising:
causing, by a third-party application of a wireless device, display of one or more user interfaces that request user authorization to capture usage data, wherein the usage data is subject to one or more limits that are enforced by an operating system of the wireless device;
receiving, by the third-party application and via one or more user interactions with the one or more user interfaces, the user authorization;
performing, by the third-party application and based on the user authorization, a first stage of a process for capturing the usage data, wherein the first stage includes:
determining, by the third-party application, a time period for capturing the usage data,
indicating, by the third-party application and to a device activity extension of the wireless device, the time period,
recording, by the third-party application, a first video of a display of the wireless device for a predetermined period of display time, wherein the first video includes at least one display screen that was caused to be displayed by the device activity extension, wherein the at least one display screen includes a depiction of a total number of screens to be displayed, and
processing, by the third-party application, the first video to extract the total number of screens to be displayed;
initiating, by the third-party application, a second stage of the process to capture the usage data, wherein the second stage includes:
recording, by the third-party application, a second video of the display of the wireless device, wherein the second video includes the usage data displayed on one or more display screens equal to the total number of screens to be displayed,
processing, by the third-party application, the second video to extract the usage data, and
sending, by the third-party application and to one or more servers via a network, the usage data.

2. The method of claim 1, further comprising:
as part of the first stage:
receiving, by the device activity extension and from the third-party application, a start time and an end time based on the time period, and
causing, by the device activity extension, display of the at least one display screen indicating the total number of screens to display; and
as part of the second stage:
causing display of the one or more display screens.

3. The method of claim 2, further comprising:
as part of the first stage:
sending, by the device activity extension, one or more queries for the usage data based on the start time and the end time, and
receiving, by the device activity extension and based on the one or more queries, the usage data.

4. The method of claim 3, wherein the start time and the end time indicate bounds for displaying the usage data during the second stage;
wherein the one or more queries are based on the bounds indicated by the start time and the end time; and
wherein the usage data is within the bounds indicated by the start time and the end time.

5. The method of claim 1, wherein the one or more limits blocks the third-party application from accessing the usage data.

6. The method of claim 1, wherein the one or more limits blocks the device activity extension from sending data from the wireless device via a network.

7. The method of claim 1, wherein the device activity extension is executed by the wireless device in a device activity sandbox, and wherein the operating system is iOS.

8. The method of claim 1, wherein recording the first video is performed for a predetermined period of extra recording time, and wherein recording the second video is performed for the predetermined period of extra recording time.

9. The method of claim 1, wherein the first stage and the second stage are performed in an automated fashion and without further user input.

10. A wireless device comprising:
one or more processors; and
memory storing executable instructions that, when executed by the one or more processors, cause the wireless device to:
cause, by a third-party application installed on the wireless device, display of one or more user interfaces that request user authorization to capture usage data, wherein the usage data is subject to one or more limits that are enforced by an operating system of the wireless device;
receive, by the third-party application and via one or more user interactions with the one or more user interfaces, the user authorization;
perform, by the third-party application and based on the user authorization, a first stage of a process for capturing the usage data, wherein the first stage includes:
determine, by the third-party application, a time period for capturing the usage data,
indicate, by the third-party application and to a device activity extension installed on the wireless device, the time period,
record, by the third-party application, a first video of a display of the wireless device for a predetermined period of display time, wherein the first video includes at least one display screen that was caused to be displayed by the device activity extension, wherein the at least one display screen includes a depiction of a total number of screens to be displayed, and
process, by the third-party application, the first video to extract the total number of screens to be displayed;
initiate, by the third-party application, a second stage of the process to capture the usage data, wherein the second stage includes:
record, by the third-party application, a second video of the display of the wireless device, wherein the second video includes the usage data displayed on one or more display screens equal to the total number of screens to be displayed,
process, by the third-party application, the second video to extract the usage data, and
send, by the third-party application and to one or more servers via a network, the usage data.

11. The wireless device of claim 10, wherein the executable instructions, when executed by the one or more processors, cause the wireless device to:
as part of the first stage:
receive, by the device activity extension and from the third-party application, a start time and an end time based on the time period, and
cause, by the device activity extension, display of the at least one display screen indicating the total number of screens to display; and
as part of the second stage:
cause display of the one or more display screens.

12. The wireless device of claim 11, wherein the executable instructions, when executed by the one or more processors, cause the wireless device to:
as part of the first stage:
send, by the device activity extension, one or more queries for the usage data based on the start time and the end time, and
receive, by the device activity extension and based on the one or more queries, the usage data.

13. The wireless device of claim 12, wherein the start time and the end time indicate bounds for displaying the usage data during the second stage;
wherein the one or more queries are based on the bounds indicated by the start time and the end time; and
wherein the usage data is within the bounds indicated by the start time and the end time.

14. The wireless device of claim 10, wherein the one or more limits blocks the third-party application from accessing the usage data, and wherein the one or more limits blocks the device activity extension from sending data from the wireless device via a network.

15. The wireless device of claim 10, wherein the device activity extension is executed by the wireless device in a device activity sandbox, and wherein the operating system is iOS.

16. One or more computer-readable media storing executable instructions that, when executed, cause a wireless device to:
cause, by a third-party application installed on the wireless device, display of one or more user interfaces that request user authorization to capture usage data, wherein the usage data is subject to one or more limits that are enforced, by an operating system of the wireless device;
receive, by the third-party application and via one or more user interactions with the one or more user interfaces, the user authorization;
perform, by the third-party application and based on the user authorization, a first stage of a process for capturing the usage data, wherein the first stage includes:
determine, by the third-party application, a time period for capturing the usage data,
indicate, by the third-party application and to a device activity extension installed on the wireless device the time period,
record, by the third-party application, a first video of a display of the wireless device for a predetermined period of display time, wherein the first video includes at least one display screen that was caused to be displayed by the device activity extension, wherein the at least one display screen includes a depiction of a total number of screens to be displayed, and
process, by the third-party application, the first video to extract the total number of screens to be displayed;
initiate, by the third-party application, a second stage of the process to capture the usage data, wherein the second stage includes:
record, by the third-party application, a second video of the display of the wireless device, wherein the second video includes the usage data displayed on one or more display screens equal to the total number of screens to be displayed,
process, by the third-party application, the second video to extract the usage data, and
send, by the third-party application and to one or more servers via a network, the usage data.

17. The one or more computer-readable media of claim 16, wherein the executable instructions, when executed, cause the wireless device to:
as part of the first stage:
receive, by the device activity extension and from the third-party application, a start time and an end time based on the time period, and
cause, by the device activity extension, display of the at least one display screen indicating the total number of screens to display,
send, by the device activity extension, one or more queries for the usage data based on the start time and the end time, and
receive, by the device activity extension and based on the one or more queries, the usage data; and
as part of the second stage:
cause display of the one or more display screens.

18. The one or more computer-readable media of claim 17, wherein the start time and the end time indicate bounds for displaying the usage data during the second stage;
wherein the one or more queries are based on the bounds indicated by the start time and the end time; and
wherein the usage data is within the bounds indicated by the start time and the end time.

19. The one or more computer-readable media of claim 16, wherein the one or more limits or restrictions blocks the third-party application from accessing the usage data, and wherein the one or more limits or restrictions blocks the device activity extension from sending data from the wireless device via a network.

20. The one or more computer-readable media of claim 16, wherein the device activity extension is executed by the wireless device in a device activity sandbox, and wherein the operating system is iOS.
